(19) United States
(12) Patent Application Publication
(10) Pub. No.: US 2014/0112149 A1
(43) Pub. Date: Apr. 24, 2014

(54) CLOSED LOOP END-TO-END QOS ON-CHIP ARCHITECTURE

(71) Applicant: STMicroelectronics (Grenoble 2) SAS, Grenoble (FR)

(72) Inventors: Ignazio Antonino Urzi, Voreppe (FR); Nicolas Graciannette, St-Nizier du Moucherotte (FR); Daniele Mangano, San Gregorio di Catania (IT)

(73) Assignee: STMicroelectronics (Grenoble 2) SAS, Grenoble (FR)

(21) Appl. No.: 14/059,252

(22) Filed: Oct. 21, 2013

(30) Foreign Application Priority Data
Oct. 22, 2012 (GB) 1218933.8

(51) Int. Cl. H04L 12/835

(52) U.S. Cl. CPC H04L 47/30
USPC 370/236

(57) ABSTRACT

An apparatus includes an output configured to output data to a communication path of an interconnect for routing to a target and a rate controller configured to control a rate of the output data. The rate controller is configured to control the rate in response to feedback information from the target.

### BACKGROUND

1. Technical Field

Embodiments relate to an apparatus and in particular but not exclusively to an apparatus for communicating with a target via an interconnect.

2. Description of the Related Art

Ever increasing demands are being placed on the performance of electronic circuitry. For example, consumers expect multimedia functionality on more and more consumer electronic devices. By way of example only, advanced graphical user interfaces drive the demand for graphics processor units (GPU). HD (High definition) video demand for video acceleration is also putting an increased demand for performance in consumer electronic devices. There is for example a trend to provide cheap 2D and 3D TV or video on an ever increasing number of consumer electronic devices.

In electronic devices, there may be two or more initiators which need to access one or more targets by a shared interconnect. Access to the interconnect needs to be managed in order to provide a desired level of quality of service for each of the initiators. Broadly, there are two types of quality of service management: static; and dynamic. The quality of service management attempts to regulate bandwidth or latency of the initiators in order to meet the overall quality of service required by the system.

### BRIEF SUMMARY

According to an aspect, there is provided an apparatus comprising: an output configured to output data to a communication path of an interconnect for routing to a target; and

a rate controller configured to control a rate of said output data, said rate controller configured to control said rate in response to feedback information from said target.

The rate may comprise at least one of bandwidth and frequency of said output data.

The controller may be configured to output a request to a communication path of said interconnect for routing to said target.

The request may be output on to one of: a different communication path to said output data and the same communication path as said output data.

The bandwidth controller may be configured to control a rate at which a plurality of requests are output in response to said feedback information.

The feedback information may comprise information about a time taken for said request to reach said target and a response to said request to be received from said target.

The feedback information may comprise information about said communication path on which said data is output.

The feedback information may comprise information about a quantity of data stored in said target.

The feedback information may comprise information on a quantity of information stored in a buffer.

The feedback information may comprise information indicating that a quantity of data stored in said target is such that the store has at least a given amount of data.

The controller may be configured to determine that if said store has at least a given amount of data, said rate is to be reduced.

The controller may be configured to estimate a current status of said target based on previous feedback information.

The controller may be configured to receive feedback information associated with a different apparatus, said different apparatus outputting data on the communication path on which said apparatus is configured to output data.

The interconnect may be provided by a network on chip.

According to another aspect, there is provided a target comprising: an input configured to receive data from an apparatus via to a communication path of an interconnect; and a feedback provider configured to provide feedback information to said apparatus, said feedback information being usable by said apparatus to control the rate at which said data is output to said communication path.

The input may be configured to receive a request from said apparatus via a communication path of said interconnect.

The feedback information may comprise information about a time taken for said request to reach said target.

The feedback information may comprise information about said communication path on which said data is received.

The feedback information may comprise information about a quantity of data stored in said target.

The feedback information may comprise information on a quantity of information stored in a buffer of said target.

The feedback information may comprise information indicating that a quantity of data stored in said target is such that the stored data is at least a given amount of data.

The feedback provider may be configured to provide feedback information associated with a different apparatus to said apparatus, said different apparatus outputting data on the communication path on which said apparatus is configured to output data.

According to another aspect, there is provided a system comprising: an apparatus as discussed above, a target as discussed above and said interconnect.

According to another aspect, there is provided an integrated circuit or die comprising: an apparatus as discussed above, a target as discussed above or said system discussed above.

According to another aspect, there is provided a method comprising: outputting data to a communication path of an interconnect for routing to a target; and controlling a rate of said output data, said rate controller configured to control said rate in response to feedback information from said target.

According to another aspect, there is provided a method comprising: receiving data from an apparatus via a communication path of an interconnect; and providing feedback information to said apparatus, said feedback information being usable by said apparatus to control the rate at which said data is output to said communication path.

### BRIEF DESCRIPTION OF THE SEVERAL VIEWS OF THE DRAWINGS

For a better understanding of some embodiments, reference will now be made by way of example only to the accompanying Figures in which:

FIG. 1 shows a device in which embodiments may be provided;

FIG. 2 shows an initiator in more detail;

FIG. 3 schematically shows a system with communication channels considered as virtual channels;

FIG. 4 schematically shows a graph of traffic classes versus time to illustrate effective DDR efficiency;

FIG. 5 schematically shows a system of an embodiment;

FIG. 6 shows in more detail a system of an embodiment;

FIG. 7 shows a further embodiment of a system;

FIG. 8 shows three graphs of illustrating the management of bandwidth requirements of two initiators; and

FIG. 9 shows a graph of service packet rate against channel filling state.

### DETAILED DESCRIPTION

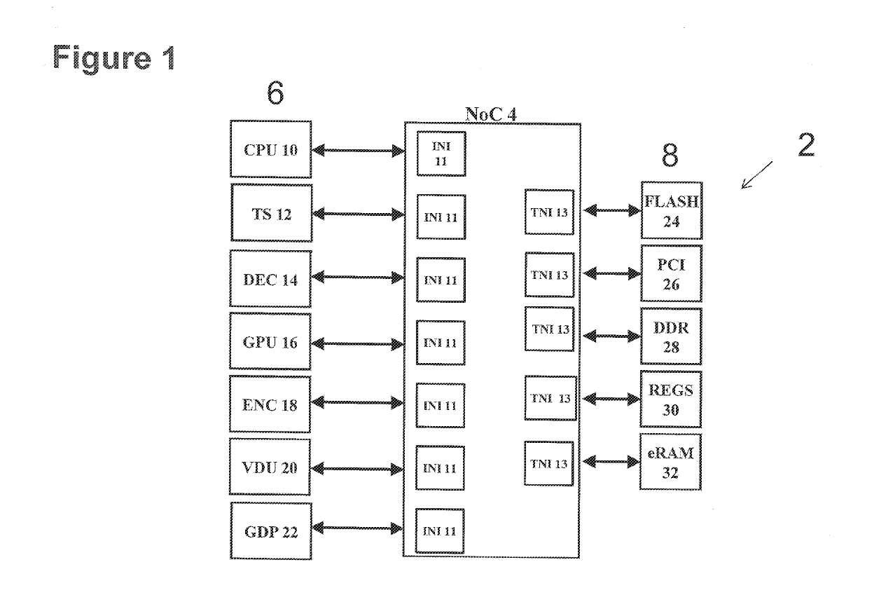

Reference is made to FIG. 1 which schematically shows part of an electronics device 2. At least part of the electronics device may be provided on an integrated circuit. In some embodiments all of the elements shown in FIG. 1 may be provided in an integrated circuit. In alternative embodiments, the arrangement shown in

FIG. 1 may be provided by two or more integrated circuits. Some embodiments may be implemented by one or more dies. The one or more dies may be packaged in the same or different packages. Some of the components of FIG. 1 may be provided outside of an integrated circuit or die. The device 2 comprises a network on chip NoC 4. The NoC 4 provides an interconnect and allows various traffic initiators (sometimes referred to as masters or sources) 6 to communicate with various targets (sometimes referred to as slaves or destinations) 8 and vice versa. By way of example only, the initiators may be one or more of a CPU (Computer Processor Unit) 10, TS (Transport Stream Processor) 12, DEC (Decoder) 14, GPU (Graphics Processor Unit) 16, ENC (Encoder) 18, VDU (Video display unit) 20 and GDP (Graphics Display Processor) 22.

It should be appreciated that these units are by way of example only. In alternative embodiments, any one or more of these units may be replaced by any other suitable unit. In some embodiments, more or less than the illustrated number of initiators may be used.

By way of example only, the targets comprise a flash memory 24, a PCI (Peripheral Component Interconnect) 26, a DDR (Double Data Rate) memory scheduler 28, registers 30 and an eRAM 32 (embedded random access memory). It should be appreciated that these targets are by way of example only and any other suitable target may alternatively or additionally by used. More or less than the number of targets shown may be provided in other embodiments.

The NoC 4 has a respective interface 11 for each of the respective initiators. In some embodiments, two or more initiators may share an interface. In some embodiments, more than one interface may be provided for a respective initiator. Likewise an interface 13 is provided for each of the respective targets. In some embodiments, two or more targets may share an interface. In some embodiments, more than one interface may be provided for a respective target.

Some embodiments will now be described in the context of consumer electronic devices and in particular consumer electronic devices which are able to provide multimedia functions. However, it should be appreciated that other embodiments can be applied to any other suitable electronic device. That electronic device may or may not provide a multimedia function. It should be appreciated that some embodiments may be used in specialized applications other than in consumer applications or in any other application. By way of example only, the electronic device may be a phone, an audio/video player, set top box, television or the like.

Some embodiments may be for extended multimedia applications (Audio, video, etc). In general, some embodiments may be used in any application where multiple different blocks providing traffic have to be supported by a common interconnect and have to be arbitrated in order to satisfy a desired Quality of Service.

Quality of service management is used to manage the communications between the initiators and targets via the NoC 4. The QoS management may be static or dynamic.

Techniques for quality of service management have been proposed to regulate the bandwidth or latency of the various system masters or initiators in order to meet the overall system quality of service. These schemes generally do not provide a fine link with real traffic behavior. Initiators normally do not consume regularly their target bandwidth. For example, a real-time video display unit does not issue traffic for most of the VBI (vertical blanking interval) period, and the traffic may be varied from one line to another due to chroma sampling.

Another issue to be considered relates to the effective bandwidth of the DDR which depends on the traffic issued by the initiator. This may lead to an increase in system latency and network on chip congestion.

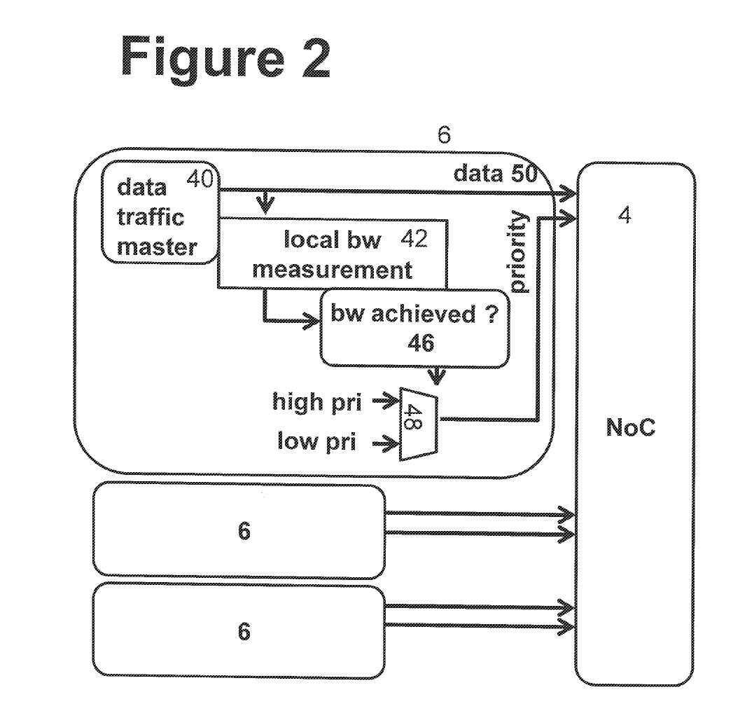

Reference is made to FIG. 2 which shows one proposal. FIG. 2 shows the network on chip 4. Three initiators 6 are shown as interfacing with the network on chip. One of the initiators 6 is shown in more detail. The initiator 6 has a data traffic master 40 which provides data 50 to the network on chip. A bandwidth counter 42 is provided to make a local bandwidth measurement. This measures the used bandwidth. The counter 42 provides an output to a comparator 46 which is configured to determine if a target bandwidth has been achieved. This may be achieved by comparing the used bandwidth with the target bandwidth. This will be based on the local bandwidth measurement. The output of the comparator 46 is used to control a multiplexer 48.

If the target bandwidth has not been achieved, the multiplexer 48 is configured to select a relatively high priority for the data 50. On the other hand, if the target bandwidth has been achieved, the multiplexer 48 is configured to select a relatively low priority for the data. The multiplexer provides a priority output in the form of priority information. This priority information will be associated with the data output by the initiator. The priority information output by the multiplexer 48 is used by an arbitrator (not shown) on the network on chip when arbitrating between requests from a number of initiators.

The network on chip technology such as shown in FIG. 2 may use static and local dynamic quality of service management in the form of bandwidth consumption and latency control. Some proposed fully static schemes are time division multiple access, mean time between requests, bandwidth limitation and fair bandwidth allocation. Examples of dynamic schemes are so called back pressure (such as described later) and priority or bandwidth regulation. However, these schemes may have a lack of visibility on the effective quality of service achieved at the ends of the network on chip infrastructure. This is because the distributed design approach and complexity of the network on chip makes network on chip state monitoring complex. In some proposals, the dynamic schemes will take a decision according to local monitoring of the quality of service (such as illustrated in FIG. 2). However, these schemes may not take into account other quality of service constraints applied on other parts of the network on chip infrastructure. This may be disadvantageous in some applications in that the network on chip infrastructure may behave as a locked-loop system.

Undesirable network behavior with a consequent low quality of service may occur if there is an unexpected bandwidth or latency bottleneck in the network on chip. This may result in the initiators raising their quality of service requirements resulting in a further degradation of quality of service. A bottleneck may occur for one or more different reasons such as due to effective DDR bandwidth variation or efficiency or the peak behavior of conflicting initiators.

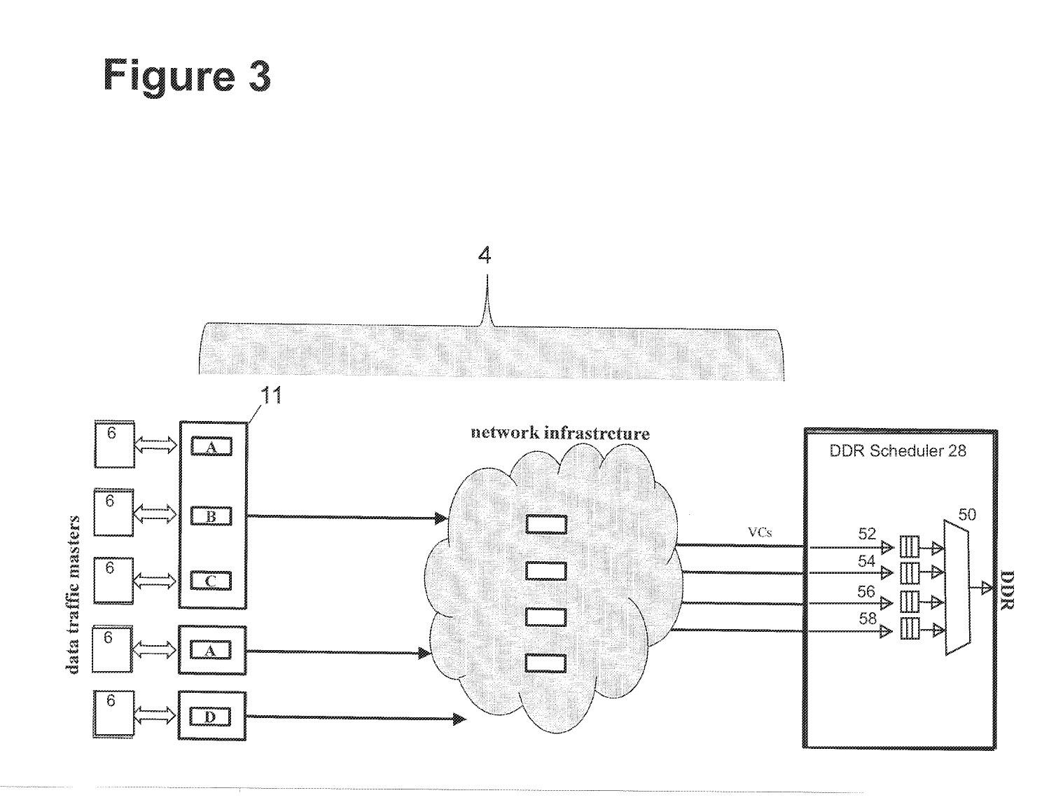

Reference is now made to FIG. 3 which shows schematically communication paths which can be conceptualized as virtualized channels. This is to permit virtualization in the overall system for the data traffic. This means that the traffic can be considered to be independent from one another while the traffic shares the same network infrastructure (network on chip) and memory target. In the examples shown in FIG. 3, the network infrastructure is a network on chip 4. The target is a DDR scheduler 28. In the example shown in FIG. 3, there are five initiators 6. In the arrangement shown in FIG. 3, virtualization is driven by the traffic classes and their respective quality of service (bandwidth and latency requirements). Virtualization leads to virtual channel usage. The scheduler 28 can be considered to have a multiplexer 50 the output of which is DDR traffic. The multiplexer 50 has four inputs, 52, 54, 56, 58. Each of these inputs can be considered to be a virtual channel. These virtual channels will generally have a different quality of service associated with it. In particular, the first virtual channel 52 has a first quality of service A. The second virtual channel 54 has a second quality of service B. The third channel 56 has a third quality of service, C and the fourth virtual channel 58 has a fourth quality of service, D.

The first initiator is arranged to output traffic having the first quality of service, A as is the fourth initiator. This traffic will be provided via the first virtual channel. The second initiator provides traffic with the second quality of service, B. The third initiator provides traffic having a third quality of service, C and the fifth initiator provides data traffic with the fourth quality of service, D. The initiators 6 are, as in the arrangement shown in FIG. 1, configured to output the data traffic to respective network interfaces 11. The outputs of the network interfaces are provided to the routing network of the network on chip. The number of resources may have to be limited and shared amongst the virtual channels. This may result in a bottleneck which is sensitive to congestion issues and the efficiency in the network on chip infrastructure may depend on the ability to control the quality of service for each virtual channel. Virtual channel usage may require dedicated hardware resources distributed in the whole network infrastructure.

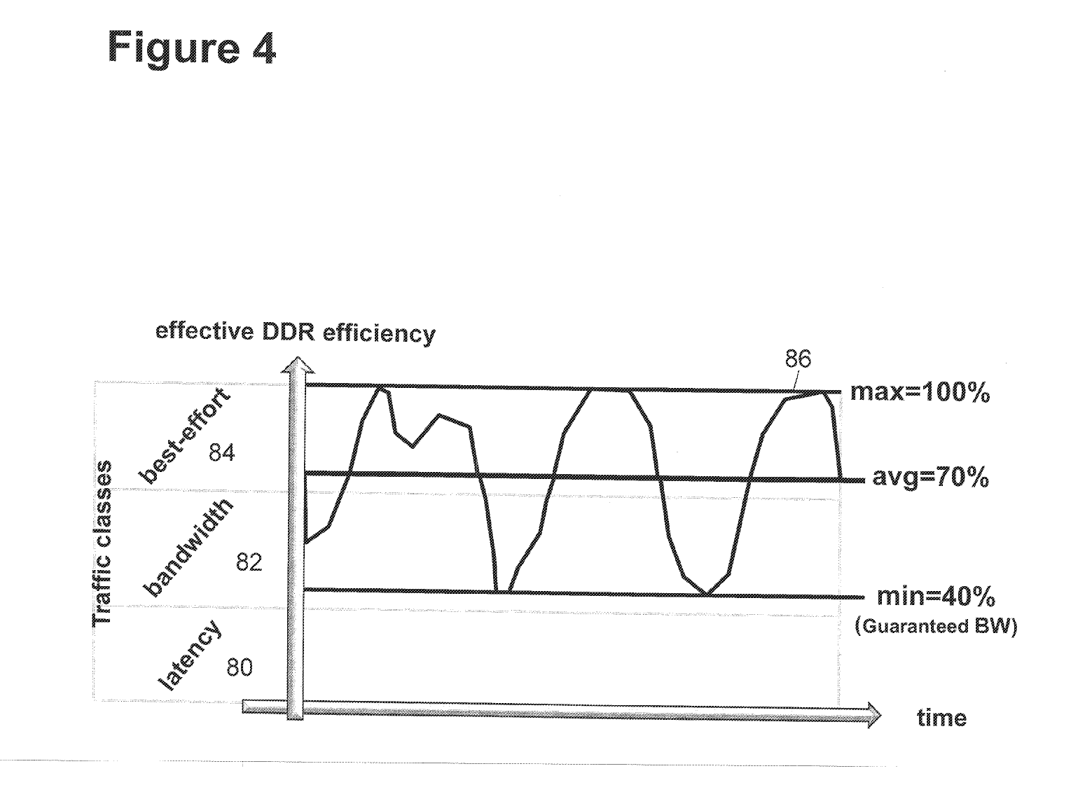

Reference is now made to FIG. 4 which shows a graph. The graph shows three traffic classes. The first traffic class is best effort and is referenced 84. This is regarded as the poorest traffic class. This class of traffic is used for traffic where there is no guarantee of bandwidth. Typically, this traffic would not be latency sensitive. This class of traffic has the lowest quality of service requirement. The second class 82 of traffic is bandwidth traffic. This class of traffic may have some quality of service requirements concerning bandwidth. The third class of traffic 80 is latency traffic. This is used for traffic which is latency sensitive. This has the highest quality of service. The system on chip takes into account the effective DDR bandwidth and allocates bandwidth slots in the network on chip accordingly in order to match the quality of service requirements for these different classes of traffic. It should be appreciated that there may be more or less than the three classes of FIG. 4. It should be appreciated that the requirements of these classes is by way of example only and one or more classes may have different quality of service requirements.

Dealing with effective DDR bandwidth results in dynamic turning off of the bandwidth of some of the traffic classes. Usually, this would be for the poorest traffic classes (e.g., class 84). However, other traffic classes may also be involved depending on their quality of service constraints. Shown on the graph and referenced 86 is the effective DDR efficiency. As can be seen, the effective DDR efficiency varies between a maximum value of 100% and a minimum value of 40%. The average value of around 70% is also shown. It should be noted that these percentage values are by way of example only. The DDR efficiency is an indication of how effectively the DDR is being used taking into account for example numbers of cycles to perform a data operation which requires access to the DDR and/or scheduling of different operations competing for access to the DDR.

The DDR scheduler may be aware of pending requests at its level. However, the scheduler may not necessarily known the exact number of pending requests in the other parts of the network on chip infrastructure. In some systems for implementing in practice an arrangement such as shown in FIG. 3 where there are shared resources, the network on chip bandwidth allocation may not match the DDR scheduler effective bandwidth. This is due to the fact that the network on chip generally has distributed arbitration stages.

In some embodiments, congestion may be avoided in the network on chip infrastructure by dynamically changing the bandwidth of some of the communication paths while maintaining the bandwidth of others. This may be based on the effective bandwidth available at the DDR scheduler level. Dynamic tuning of bandwidth in a communication path may be performed in a number of different scenarios where the bandwidth offered by the infrastructure is not easily predictable. This may be for example from network-on-chip-island to network-on-chip-island, from initiator to DDR or the like.

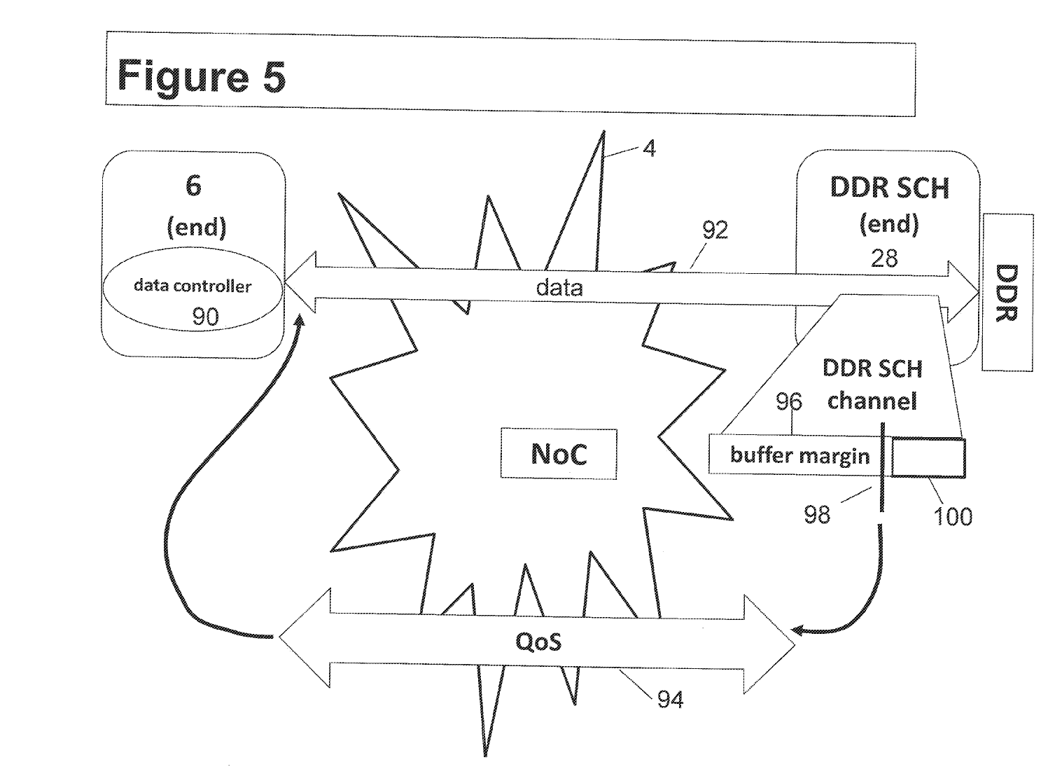

Reference will now be made to FIG. 5 which shows an embodiment. In this embodiment, a per-communication path credit-based locked-loop approach between the DDR scheduler and the initiator is provided. This may avoid congestion in the network on chip infrastructure and may not have a hardware impact on the network on chip architecture.

In some embodiments, the quantity of pending requests for a communication path may be indirectly monitored at the scheduler level. The rate of data output by the initiator may be controlled so that the communication path does not become full and congestion may not occur. A DDR scheduling algorithm may regulate the initiator data rate depending on the DDR scheduler monitoring. The DDR scheduler may have buffering capabilities (buffer margin) to fully or partially cover an unknown number of hidden requests. These requests would be requests which are in transit in the network on chip. In some embodiments, the existing communication resources for end-to-end information transfer may be used.

FIG. 5 shows an initiator 6. The initiator is configured to send data via a communication path 92 to the DDR scheduler 28. The initiator 6 has a data controller 90 which controls the rate at which data is output to the communication path 92. The initiator 6 initiates a service packet, at a programmable rate, as a request. This request is inserted into the communication path 92. In some embodiments, this service packet may be inserted into a different communication path.

The service packet may simply be a data packet or may be a specific packet. Alternatively or additionally a data packet may be modified to include information or an instruction to trigger a response. The service or data packet is sent to trigger a response from the DDR scheduler. The service packet may be used to feedback information to the scheduler, for example on round trip latency, as will be described later. In some embodiments, the service packet request may be used as a measure of the latency of the communication path. Information on the latency of the path and on a buffer may be provided back to the initiator in order to provide information which can be used for End-to-End quality of service.

In some embodiments, the service or data packet may be omitted and a different mechanism may be used to trigger the sending of information from the DDR scheduler back to the initiator. This may be used to provide information on the status of the buffer.

In one embodiment, separate service packets and user data packets are provided. The user data packet comprises a header and a payload. The payload of a user data packet comprises user data. The header comprises a packet descriptor. This packet descriptor will include a type identifier. This type identifier will indicate that the packet contains user data. The packet descriptor may additionally include further information such as size or the like. The header also includes a network on chip descriptor. This may include information such as a routing address or the like.

The service packet also has a header and a payload. The payload of a service packet comprises a service descriptor with information such as the channel state for end-to-end quality of service or the like. The header comprises a packet descriptor. The packet descriptor will include a type identifier which will indicate that the packet is a service packet. The packet descriptor may include additional information such as size or the like. As with the user data packet, the header will include a network on chip descriptor which will include information such as, for example, a routing address or the like.

The type ID field of the service packet and user data packet are analyzed in order to properly manage the packet.

The DDR scheduler has a buffer 96 which is arranged to store the DDR scheduler pending requests. This buffer has a threshold 98. When the quantity of data in this buffer 96 exceeds this threshold 98, this will cause the response to the service packet to include this information. Where provided communication path 94 may be used for end-to-end quality of service and is separate from communication path 92, used for the service request packet. A dedicated feedback path 94 may be such that the delays on this path are minimized. Alternatively, the response may use the same communication path 92 as used for the service request packet. This information is fed back to the data processor 90 which controls the rate at which data is put onto the communication path 92 in response to that feedback.

Alternatively or additionally the exceeding of the threshold may itself trigger the sending of a response or a message to the initiator via communication path 92 or 94.

To summarize, the service packet request may be provided on the same communication path as the data or a different communication path to the data. The service packet response may be provided on the same communication path as the service packet request, the same communication path as the data (where different to that used for the service packet request) or a communication path different to that used for the service packet request and/or data.

Some embodiments may have a basic locked loop where the data traffic from an initiator is tuned thanks to information at the DDR scheduler level and a go/no-go scheme. The service packet response is thus returned by the DDR scheduler with the current state of the related communication path 92. This information is determined from the status of the buffer.

If the service packet is sent via the communication path 92 which is used for data, the service packet response will be removed from the data traffic at the initiator level, in some embodiments. In some embodiments, the service packet will enter a dedicated communication path resource in the DDR scheduler where the communication path latency may not depend on related or other data communication path latency associated with a DDR. In other words the data which is received by the scheduler may then need to wait a further length of time before it is scheduled for the DDR. The service packet is removed from the data communication path such that the service packet does not have this further length of time delay.

The initiator may be controlled in any suitable way in response to the feedback from the DDR scheduler. For example, the traffic may be enabled by default until a communication path full state (determined by the status of the buffer) is returned by the DDR scheduler. The traffic will be resumed for example after a predetermined period or time out. Alternatively or additionally, the data traffic may be suspended by default. A communication path ready state will allow traffic for a given amount of time, for example, until a time out. Alternatively or additionally, the traffic may be enabled on reception of the communication path ready state and suspended upon a communication path full state.

The message or response which is sent from the DDR scheduler back to the initiator is determined by the state of the buffer. In some embodiments, the threshold is set such that data which has been sent from the initiator but not yet received can be accommodated. Thus, a margin may be provided in some embodiments. In some embodiments, more than one threshold may be provided. In some embodiments, the falling below a threshold may determine the nature of the response. In other embodiments, a different measure related to the buffer may be used instead of or in addition to a threshold.

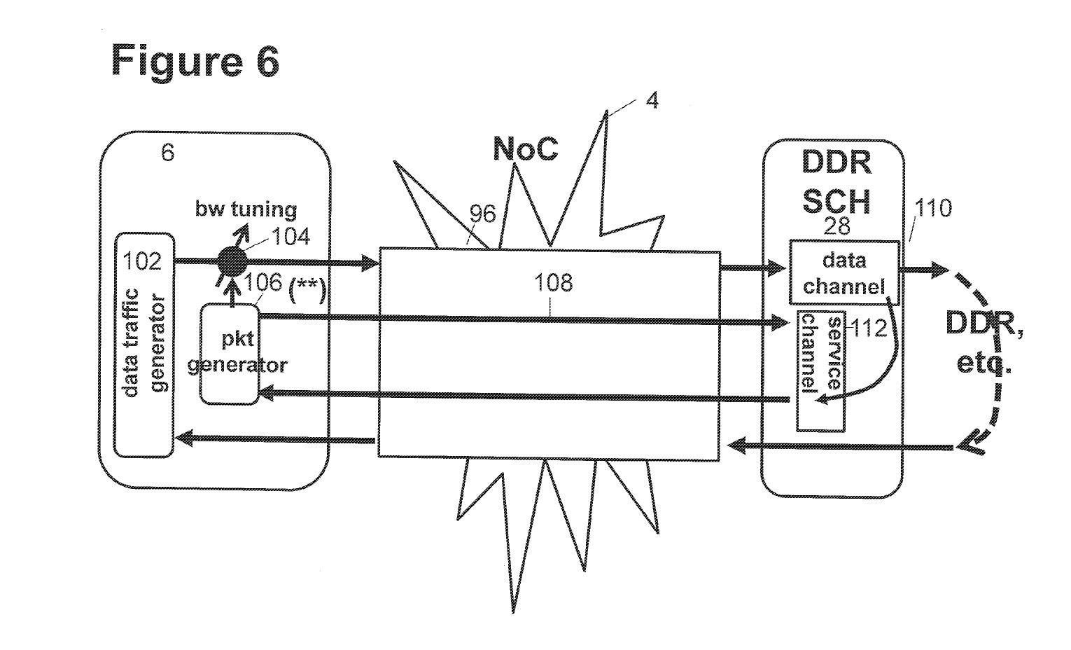

Reference is now made to FIG. 6. This shows the initiator 6 and the DDR scheduler 28 communicating via the network on chip 4. The initiator 6 has a data traffic generator 102. This data traffic generator is configured to put the data traffic onto the communication path 96. A bandwidth tuner 104 controls the rate at which data is put onto the communication path 96. The bandwidth tuner 104 is controlled by a packet generator 106. The packet generator 106 is configured to provide the so called service packet. This service packet is put on to the communication path 96. Schematically the service packet is represented by line 108. However, in some embodiments it should be appreciated that a single communication path is used both for the data from the initiator and the service packet. The data which is transported via the network on chip is received by the data communication path buffer 110 of the DDR scheduler 28. This data communication path buffer will store the data. The data will ultimately be output by the buffer 110 to the DDR. Data may be returned to the initiator 6 by the same or a different communication path 96.

Information on the status of the buffer is provided to a processor 112. The processor is configured to provide the response to the service packet from the packet generator 106, as soon as possible in some embodiments. The response which is received by the packet generator 106 is used to control the bandwidth tuner 104. This may increase the rate at which packets are put on to the communication path, slow the rate at which packets are put into the communication path, stop the putting of packets onto the virtual communication path and/or start the putting of packets onto the communication path.

It should be appreciated that there may be more than one service packet for which a response is outstanding. In other words a response to a service packet does not need to be received in some embodiments in order for the next service packet to be put onto the communication path (although this may be the case in some embodiments).

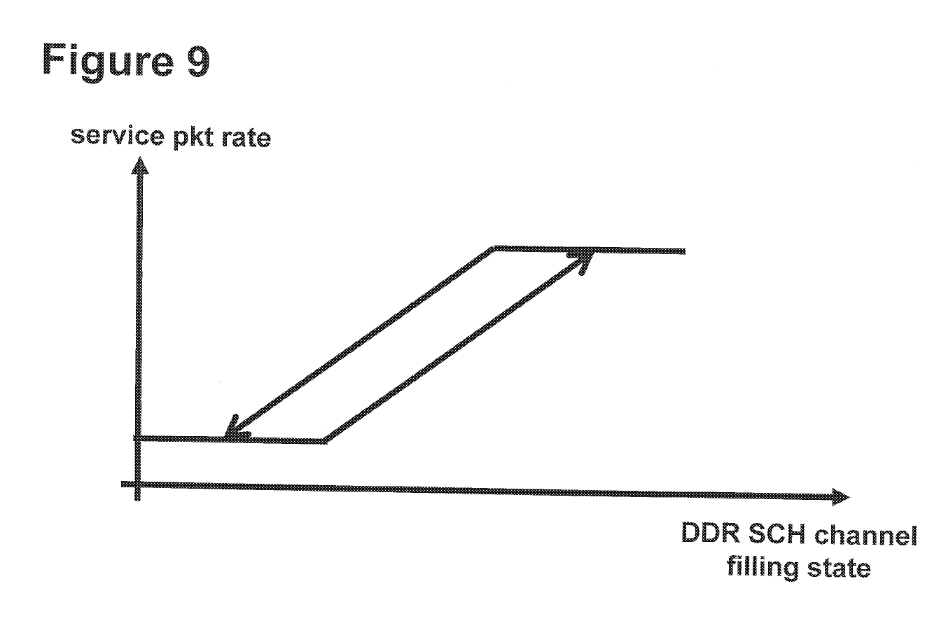

The rate at which service packets are put onto communication path may be controlled in some embodiments. FIG. 9 shows a graph of service packet request issuance rate against the communication path filling state (filling state of the buffer). As can be seen, the fuller the buffer the more frequent the service packets and the emptier the buffer the less frequent the packets. The graph also shows that in this embodiment, account is taken as to whether the buffer is filling up or emptying. If the buffer is filling put then the service packet rate is higher than if the buffer is emptying.

In some embodiments, the service packet traffic is configured to have a higher priority over the data traffic. In some embodiments, a minimum bandwidth budget ensures that the service packet may always be transferred between the initiator and the scheduler. Where the service packet is sharing a communication path with other packets, the service packets may be given priority over that minimum bandwidth.

In one alternative embodiment, two separate communication paths may be provided. The first communication path is for the data from the initiator. The second communication path will be for the service packet communication between the initiator and the scheduler.

The one or more communication paths may be bidirectional or may be replaced by two separate communication paths, one for each direction.

Some embodiments may improve the locked-loop accuracy and speed. Some embodiments may have a more sustainable bandwidth estimation. Some embodiments may have a bandwidth overhead limitation due to the service packet usage. In some embodiments, there may be optimization of the buffering capabilities of the scheduler.

The accuracy of the loop error due to service packet response time can be improved by control carried out in the initiator. That control may be performed by the packet generator and/or any other suitable controller. The packet generator and/or other controller may use a suitable algorithm. The latency of the service packet response has an impact on how quickly the initiator is able to react to changes in congestion in the communication path. The algorithm may for example make predictions on the current buffer status, before the corresponding response packet has been received. These predications may be made on the basis of the previous responses and/or the absence of a response to one or more outstanding service packets and/or any other information. These predictions may cancel or at least partially mask the effects of the service packet response latency. In some embodiments, if the algorithm is able to mitigate at least partially the effects of the service packet response latency, the buffer margin may be smaller.

Additionally or alternatively the rate of issuance of the service packet response may be controlled.

Some embodiments may provide more service packet information from the scheduler and linear algorithms at the initiator level. This may be for one or more of the following reasons. Firstly, this may be used in relation to the filling level of the related data communication path. The buffer provides the filling information as a measure of the filling level of the communication path; in other words, the number of outstanding requests that can be handled. This information may be used for derivation; in other words, whether the situation in the communication path becomes better or worse. In some embodiments, this information can be used for self-regulation of the service packet issuing rate. In some embodiments, further information can be used for integration and recursive analysis of service packets, as discussed previously.

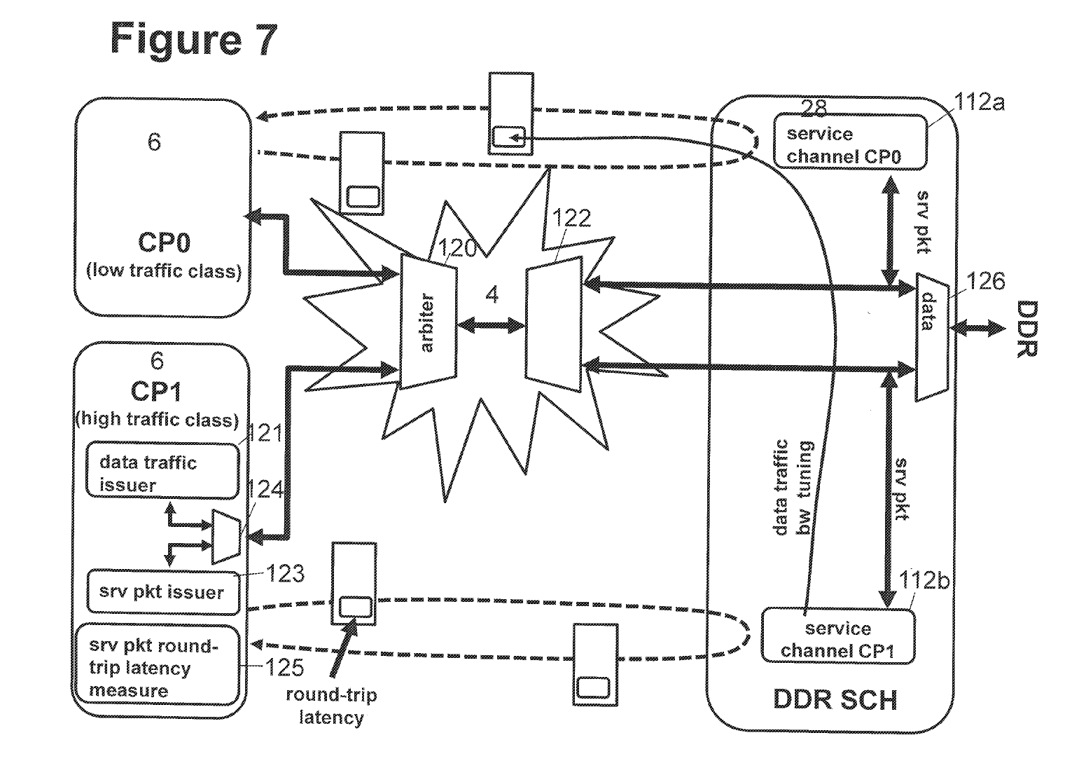

Reference is made to FIG. 7 which shows a further embodiment. In the embodiment shown in FIG. 7, there is a first initiator 6 and a second initiator 6. The two initiators communicate with the DDR scheduler 28 via the network on chip 4. The network on chip 4 has an arbiter 120 which is configured to arbitrate transactions between the initiators and the network on chip.

The network on chip has an arbiter 122 which is configured to arbitrate requests between the network on chip and the DDR scheduler 28. In the arrangement shown in FIG. 7, the first initiator is associated with a first communication path CP0. This communication path is a low traffic class channel. The second initiator is associated with a second communication path CP1. This is a high level traffic class. In the arrangement shown in FIG. 7, there is a shared resource in the network on chip between the first and second communication paths CP0 and CP1. This may give rise to a risk of a bottleneck with a congestion risk. In the example shown in FIG. 7, the first initiator is configured to put data and the service packets on the same communication path. Likewise, the second initiator 6 is also configured to put data and service packets on the same communication path.

As schematically shown, the second initiator has a multiplexer 124. The multiplexer 124 selectively outputs a service packet from a service packet issuer 123 or a data traffic packet from a data traffic issuer onto the communication path. Although this is not specifically shown in the previous Figures, it should be appreciated that such an arrangement may be included in any of the previously described arrangements.

The second initiator has a measurer 125 which is configured to measure the service packet round trip. This is the time taken for a service packet issued from the second initiator to be received by the DDR scheduler, and a response to be issued from the DDR scheduler to that packet and received back at the second initiator. This provides a measure of the latency in the system and a measure of congestion. It should be appreciated that the first initiator may have a similar service packet round-trip latency measurer. The DDR scheduler 28 is configured to have a first service communication path processor 112a for the first communication path CP0. The scheduler also has a second service communication path processor 112b associated with the second communication path CP1. The data which is received from the network on chip is provided to a data multiplexer 126 which is able to output the data from the first and second communication paths to the DDR. The respective service packets are provided to the respective service communication path processor. Thus service packets on the first communication path are provided to the first service communication path processor 112a. Likewise, service packets on the second communication path are provided to the second service communication path processor 112b.

The arrangement of FIG. 7 may be used in embodiments where there is end-to-end quality of service control among two or more communication paths in order to address network on chip congestion issues. In this embodiment, the service packet is used as a marker of local network on chip congestion. In particular, as illustrated schematically, information associated with the second communication path CP1 may be fed back to the first communication path (and/or vice versa). This embodiment may not require local network on chip congestion management. The arrangement of FIG. 7 may be used where the virtual channels of FIG. 3 are difficult to implement. In some embodiments local congestion at for example the multiplexers on the NoC may be avoided. Some embodiments may compensate for relatively poor arbitration algorithms at the multiplexers.

Thus, as described, there is a round trip latency measure of the service packet trip at the initiator. This may be combined with any issuing rate method. The round-trip latency information will be transferred to the DDR scheduler in a subsequent service packet request. In other words, the latency associated with an earlier service packet request and the associated response will be provided to the DDR scheduler in a later service packet request.

At the DDR scheduler level, the DDR scheduler is able to analyze the round-trip latency variation. End-to-end quality of service control can be performed on the communication paths involved in congestion and associated with the lowest traffic class, in some embodiments. Depending on this analysis, the response will be used to control for example a bandwidth tuner.

In some embodiments, a calibration is performed. This is to estimate the nominal communication path latency. This may be done in a test phase where there is no data on the network on chip and instead one or more service packets are issued and responded to in order to determine the latency in the absence of congestion. This latency may be the static latency.

It should be appreciated that in some embodiments, control across a single communication path may be exerted as well as control over two or more communication paths. In other words, the embodiments described previously in relation to for example FIG. 5 can be used in conjunction with the control described particularly in relation to FIG. 7.

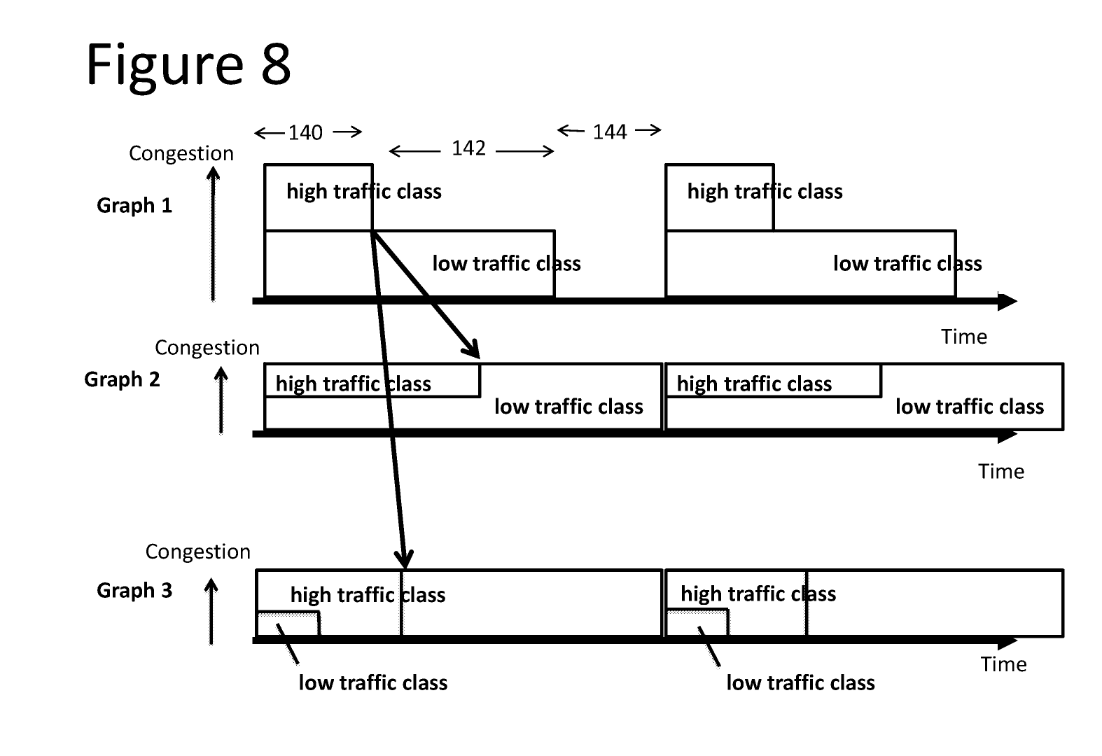

Reference is made to FIG. 8 which schematically shows how the embodiment of FIG. 7 may manage traffic. The graphs schematically represent congestion against time. The raw traffic without any control is shown first in Graph 1. Initially, in a first period 140, high quality of service traffic is competing with low quality of service traffic. This respectively corresponds to the traffic from the second initiator and the first initiator. Thus congestion is relatively high. In a next period 142, there is only the low quality of service traffic class. In a third period 144, there is no traffic from either of the initiators. Accordingly, as can be seen, the first period has a high level of congestion, the second period a lower level of congestion and the third period no congestion.

By way of comparison, two traffic classes are shown in Graph 2 where network on chip arbitration drives the bandwidth allocation among the traffic classes. Graph 2 may be the result of using a system such as shown in FIG. 2. As can be seen, the traffic class with the higher quality of service extends now through the first period and a substantial part of the second period. In other words, the latency of the traffic with the high quality of service is impacted. This may be undesirable in some embodiments. The traffic class with the lower quality of service is now transmitted throughout the three periods. This would be the scenario without end-to-end locked loop control, such as previously discussed.

In the third Graph 3 of FIG. 8, the distribution of the traffic classes in accordance with an embodiment is shown. In particular, this traffic distribution provides the achieved bandwidth at the network on chip level where end-to-end locked loop control is provided. The end-to-end locked loop takes ownership over the local network on chip arbitration. Initially, the traffic with the high quality of service and the traffic with the low quality of service share the available bandwidth. However, as soon as feedback can be provided to the respective initiators, the high traffic class will take control of all of the bandwidth with the traffic having a lower quality of service delayed. The traffic with the lower quality of service requirement is stopped until the traffic class with a higher quality of service has been transmitted. As can be seen from a comparison of graphs 1 and 3, there will be a minimum latency with the arrangement of the embodiment and congestion problems may be avoided.

It should be appreciated that the communication path may be any suitable communication resource and may for example be a channel. In some embodiments, the communication path can be considered to be a virtual channel.

It should be appreciated that one or more of the functions discussed in relation to one or more sources and/or one or more targets may be provided by one or more processors. The one or more processors may operate in conjunction with one or more memories. Some of the control may be provided by hardware implementations while other embodiments may be implemented in by software which may be executed by a controller, microprocessor or the like. Some embodiments may be implemented by a mixture of hardware and software.

While this detailed description has set forth some embodiments of the present invention, the appending claims cover other embodiments of the present invention which differ from the described embodiments according to various modifications and improvements. Other applications and configurations may be apparent to the person skilled in the art. Some of the embodiments have been described in relation to an initiator and a DDR scheduler. It should be appreciated that this is by way of example only and the target may be any initiator and target may be any suitable apparatus. Alternative embodiments may use any suitable interconnect instead of the example Network-on-Chip.

The various embodiments described above can be combined to provide further embodiments. The embodiments may include structures that are directly coupled and structures that are indirectly coupled via electrical connections through other intervening structures not shown in the figures and not described for simplicity. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An apparatus comprising:
an output configured to output data to a selected communication path of an interconnect for routing to a target; and
a rate controller configured to control a rate of said output data, said rate controller configured to control said rate in response to feedback information from said target.

2. An apparatus as claimed in claim 1 wherein said rate comprises at least one of bandwidth and frequency of said output data.

3. An apparatus as claimed in claim 1 wherein said rate controller is configured to output a request to a first communication path of said interconnect for routing to said target.

4. An apparatus as claimed in claim 3 wherein said first communication path is chosen from the selected communication path of the interconnect for routing to the target and a different communication path of said interconnect.

5. An apparatus as claimed in claim 3 wherein a bandwidth controller is configured to control a rate at which a plurality of requests are output in response to said feedback information.

6. An apparatus as claimed in claim 3 wherein said feedback information comprises information about a time taken for said request to reach said target and a response to said request to be received from said target.

7. An apparatus as claimed in claim 1 wherein said feedback information comprises information about said selected communication path on which said data is output.

8. An apparatus as claimed in claim 1 wherein said feedback information comprises information about a quantity of data stored in said target.

9. An apparatus as claimed in claim 1 wherein said feedback information comprises information about a quantity of information stored in a buffer.

10. An apparatus as claimed in claim 8 wherein said feedback information comprises information indicating that the quantity of data stored in said target is at least a given amount of data.

11. An apparatus as claimed in claim 10 wherein said rate controller is configured to reduce the rate of said output data if said data stored in said target is at least a given amount of data.

12. An apparatus as claimed in claim 1 wherein said rate controller is configured to estimate a current status of said target based on previous feedback information.

13. An apparatus as claimed in claim 1 wherein said rate controller is configured to receive different feedback information associated with a different apparatus, said different apparatus outputting data on the selected communication path of the interconnect for routing to the target.

14. An apparatus as claimed in claim 1 wherein the interconnect is provided by a network on chip.

15. A target comprising:
an input configured to receive data from an apparatus via a selected communication path of an interconnect; and
a feedback provider configured to provide feedback information to said apparatus, said feedback information being usable by said apparatus to control a rate at which said data is output to said selected communication path.

16. A target as claimed in claim 15 wherein said input is configured to receive a request from said apparatus via a communication path of said interconnect.

17. A target as claimed in claim 15 wherein said feedback information comprises information about a time taken for a request to reach said target.

18. A target as claimed in claim 15 wherein said feedback information comprises information about said selected communication path of the interconnect on which said data is received.

19. A target as claimed in claim 15 wherein said feedback information comprises information about a quantity of data stored in said target.

20. A target as claimed in claim 19 wherein said feedback information comprises information about a quantity of information stored in a buffer of said target.

21. A target as claimed in claim 19 wherein said feedback information comprises information indicating that the quantity of data stored in said target is at least a given amount of data.

22. A target as claimed in claim 15 wherein said feedback provider is configured to provide feedback information associated with a different apparatus, said different apparatus outputting data on the selected communication path of the interconnect.

23. A system comprising:
an interconnect coupling an apparatus to a target,
wherein the apparatus includes:
an output configured to output data to a selected communication path of the interconnect for routing data to the target; and
a rate controller configured to control a rate of the output data, the rate controller configured to control the rate in response to feedback information from the target; and
wherein the target includes:
an input configured to receive the data from the apparatus via the selected communication path of an interconnect; and
a feedback provider configured to provide the feedback information to the apparatus, the feedback information being usable by the apparatus to control the rate at which the data is output to the selected communication path.

24. The system as claimed in claim 23 wherein the apparatus, the target, and the interconnect are formed in an integrated circuit.

25. A method comprising:
outputting data to a communication path of an interconnect for routing to a target; and
controlling with a rate controller a rate of outputting said data, said rate controller configured to control said rate of outputting in response to feedback information from said target.

26. A method as claimed in claim 25, comprising:
receiving the feedback information from the target, wherein the feedback information includes information about a quantity of data stored in the target; and
reducing the rate of outputting the data if the quantity of data stored in the target is at least a given amount of data.

27. A method comprising:
receiving data from an apparatus via a communication path of an interconnect; and
providing feedback information to said apparatus, said feedback information being usable by said apparatus to control a rate at which said received data is output by said apparatus to said communication path.

28. A method as claimed in claim 27, comprising:
calculating the feedback information based on a quantity of data stored in a buffer; and
receiving additional data from the apparatus at a reduced rate via the communication path of the interconnect.
